(19) United States
(12) Patent Application Publication
(10) Pub. No.: US 2009/0066255 A1
(43) Pub. Date: Mar. 12, 2009

(54) LIGHTING CONTROL APPARATUS FOR VEHICLE

(75) Inventors: Kunikazu Nakayama, Nagoya-city (JP); Kazuya Takasaki, Chiryu-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/197,414

(22) Filed: Aug. 25, 2008

(30) Foreign Application Priority Data
Sep. 11, 2007 (JP) 2007-235542

(51) Int. Cl. B60Q 1/14

(52) U.S. Cl. 315/77

(57) ABSTRACT

A lighting control apparatus includes a portable device, an interior antenna, an exterior antenna, a controller, and a lighting device. The interior antenna has a communicating area at an inside of a vehicle compartment and an exterior antenna has a communicating area at an outside of the vehicle compartment. The controller determines a position of the portable device through one of the interior antenna and the exterior antenna when the portable device is in the communicating area of the one of the interior antenna and the exterior antenna. The lighting devise is disposed at a roof of the vehicle adjacent to a door of the vehicle and illuminates one of the inside of the vehicle compartment and the outside of the vehicle compartment in accordance with the position of the portable device determined by the controller.

### CROSS REFERENCE TO RELATED APPLICATIONS

The present application is based on and claims priority to Japanese Patent Application No. 2007-235542 filed on Sep. 11, 2007, the contents of which are incorporated in their entirety herein by reference.

### BACKGROUND OF THE INVENTION

1. Field of the Invention

The present invention relates to a lighting control apparatus for a vehicle.

2. Description of the Related Art

US 2006/0046684 A (corresponding to JP-A-2006-069296A) discloses a system that activates a head lamp, a hazard lamp, or a room lamp of a vehicle so as to illuminate a periphery of the vehicle or an inside of a vehicle compartment for assisting a user to open a door of the vehicle or to get in and out of the vehicle. By detecting that the user comes close to the vehicle, the present system activates the head lamp, the hazard lamp, or the room lamp.

However, when the head lamp or the hazard lamp is activated, only a front side or a rear side of the vehicle is illuminated and a portion in the vicinity of the door is difficult to be illuminated. Thus, the present system is difficult to assist the user to open the door or to get in and out of the vehicle, sufficiently. Even when the room lamp is activated, only the inside of the vehicle compartment is illuminated, and an outside of the vehicle is difficult to be illuminated sufficiently.

In another user assisting system, a lighting device is disposed at a door mirror of a vehicle. The lighting device is activated when a user gets in and out of the vehicle for assisting the user.

In the present system, the lighting device can illuminate an outside of the vehicle. However, the present system requires the lighting device disposed at the door mirror and a driving device for the lighting device in addition to a driving device for a room lamp.

### SUMMARY OF THE INVENTION

In view of the foregoing problems, it is an object of the present invention to provide a lighting control apparatus.

According to an aspect of the invention, a lighting control apparatus for a vehicle includes a portable device, an interior antenna, an exterior antenna, a controller, a first lighting device, and a second lighting device. The interior antenna has a communicating area at an inside of a vehicle compartment. The exterior antenna has a communicating area at an outside of the vehicle compartment. The controller determines a position of the portable device through one of the interior antenna and the exterior antenna when the portable device is in the communicating area of the one of the interior antenna and the exterior antenna. The first lighting device is disposed at a portion of a roof of the vehicle adjacent to a left door of the vehicle, The second lighting device is disposed at a portion of the roof adjacent to a right door of the vehicle. Each of the first lighting device and the second lighting device is configured to illuminate one of the inside of the vehicle compartment and the outside of the vehicle compartment in accordance with a control signal from the controller. The controller sends the control signal to one of the first lighting device and the second lighting device so as to illuminate the inside of the vehicle compartment when the controller determines that the portable device is in the communicating area of the interior antenna. The controller sends the control signal to one of the first lighting device and the second lighting device so as to illuminate the outside of the vehicle compartment when the controller determines that the portable device is in the communicating area of the exterior antenna.

The present lighting control apparatus can provide a foot illumination by using one the first lighting device and second lighting device when a user having the potable device comes close to the vehicle.

### BRIEF DESCRIPTION OF THE DRAWINGS

Additional objects and advantages of the present invention will be more readily apparent from the following detailed description of preferred embodiments when taken together with the accompanying drawings. In the drawings:

FIG. 1 is a block diagram illustrating a lighting control apparatus according to a first embodiment of the invention;

FIG. 2 is a top layout view of a vehicle provided with the lighting control apparatus according to the first embodiment;

FIG. 3 is a flow chart illustrating an exemplary process for controlling the lighting control apparatus according to the first embodiment;

FIG. 4 is a block diagram illustrating a lighting control apparatus according to a second embodiment of the invention;

FIG. 5 is a top layout view of a vehicle provided with the lighting control apparatus according to the second embodiment;

FIG. 6 is a top layout view of a vehicle provided with a lighting control apparatus according to a third embodiment of the invention; and

FIG. 7 is a block diagram illustrating a lighting control apparatus according to a fourth embodiment of the invention.

### DETAILED DESCRIPTION OF THE PREFERRED EMBODIMENTS

### First Embodiment

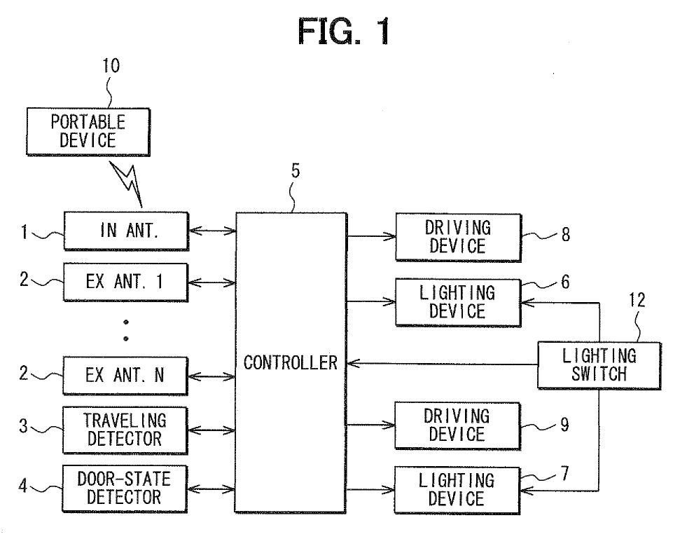

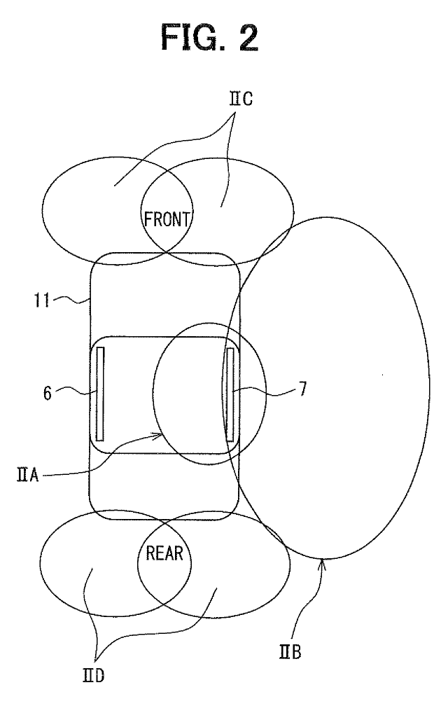

A lighting control apparatus according to a first embodiment of the invention will be described with reference to FIG. 1 and FIG. 2.

The lighting control apparatus includes an interior antenna (IN ANT) 1, a plurality of exterior antennas (EX ANT.1-EX ANT.N) 2, a traveling detector 3, a door-state detector 4, a controller 5, lighting device 6 and 7, and driving devices 8 and 9.

The interior antenna 1 and the exterior antennas 2 communicate with a potable device 10 for detecting whether a user having the portable device 10 is in a vehicle compartment, the user is in the vicinity of a vehicle 11, or the user is far from the vehicle 11. For example, each of the interior antenna 1 and the exterior antennas 2 sends a confirming signal to a communicating area thereof based on a command signal from the controller 5. When the portable device 10 is in one of the communicating areas and receives the confirming signal, the portable device 10 outputs a reply signal. The corresponding one of the interior antenna 1 and the exterior antennas 2 receives the reply signal and sends the reply signal to the controller 5. The communicating area of the interior antenna 1 is provided at a predetermined area in the vehicle compartment. The communicating areas of the exterior antenna 2 are provided at different areas of an outside of the vehicle 11. For example, the communicating areas of the exterior antennas 2 may be provided at predetermined areas from respective doors of the vehicle 11. The exterior antennas 2 may also include one exterior antenna 2 having the communicating area on a right side of the vehicle 11 and another exterior antenna 2 having the communicating area on a left side of the vehicle 11.

A smart entry system (registered trademark) includes an interior antenna, an exterior antennas and a portable device having similar functions to the interior antenna 1, the exterior antenna 2, and the portable device 10, respectively, Thus, the interior antenna, the exterior antennas and the portable device for the smart entry system may be used for the lighting control apparatus.

The traveling detector 3 detects whether the vehicle 11 is traveling based on a detecting signal from a speed sensor or a wheel speed sensor, or a data on a vehicle speed calculated at an electronic control unit based on the detecting signal. The traveling detector 3 outputs a detecting signal to the controller 5 in accordance with the traveling state of the vehicle 11.

The door-state detector 4 detects an open/close state and a lock/unlock state of each door of the vehicle 11. For example, the door-state detector 4 is configured with a door switch disposed adjacent to a center pillar of a body of the vehicle. The door-state detector 4 outputs a detecting signal to the controller 5 in accordance with the state of the doors.

The controller 5 is constituted by a microcomputer including a central processing unit (CPU), a read-only memory (ROM), a random access memory (RAM), and an input and output device (I/O). The controller 5 executes a process based on a program stored in the RAM, for example. The controller 5 sends the command signal to the interior antenna 1 and the exterior antennas 2 so that the interior antenna 1 and the exterior antennas 2 send the confirming signal with a predetermined cycle. When the portable device 10 receives the confirming signal and sends the reply signal, the controller 5 receives the reply signal through one of the interior antenna 1 and the exterior antennas 2. The controller 5 determines the position of the user based on which antenna receives the reply signal. The portable device 10 and the controller 5 may store an identification code set with each vehicle. In the present case, the portable device 10 adds the identification code to the reply signal and the controller 5 determines whether the identification code stored therein corresponds to the identification code in the reply signal. When the identification code stored in the controller 5 corresponds to the identification code in the reply signal, the controller 5 determines the position of the portable device 10. The controller 5 further receives the detecting signals from the traveling detector 3 and the door-state detector 4 and determines whether the vehicle 11 is traveling and whether each door is open. The controller 5 sends control signals to the lighting devices 6 and 7 and the driving devices 8 and 9 in accordance with the position of the portable device 10, the traveling state of the vehicle 11, and the open/close state of the doors.

The lighting devices 6 and 7 are disposed in the vehicle compartment. Each of the lighting devices 6 and 7 is activated or deactivated in accordance with the control signal from the controller 5. Each of the lighting devices 6 and 7 can be used as an interior lighting and an exterior lighting. For example, as illustrated in FIG. 2, the lighting device 6 is disposed at a portion of a roof of the vehicle 11 adjacent to a left door and the lighting device 7 is disposed at a portion of the roof adjacent to a right door. Each of the lighting devices 6 and 7 extends from a front side to a rear side of the vehicle compartment. Each of the lighting devices 6 and 7 may be constituted by a plurality of incandescent lamps or a fluorescent lamp. Each of the lighting devices 6 and 7 may also be constituted by other element as long as the other element can illuminate an area extending from the front side to the rear side of the vehicle.

For example, each of the lighting devices 6 and 7 is rotatable on an axis approximately parallel to a front-rear direction of the vehicle 11. The driving device 8 rotates the lighting device 6 so as to switch a state where the lighting device 6 functions as the interior lighting for illuminating the inside of the vehicle compartment and a state where the lighting device 6 functions as the exterior lighting for illuminating the outside of the vehicle compartment. The driving device 9 rotates the lighting device 7 so as to switch a state where the lighting device 7 functions as the interior lighting for illuminating the inside of the vehicle compartment and a state where the lighting device 7 functions as the exterior lighting for illuminating the outside of the vehicle compartment, When the lighting device 7 arranged along the right door is used as the interior lighting, the lighting device 7 has a lighting area IIA including a right half of the vehicle compartment, as illustrated in FIG. 2. When the lighting device 7 is used as the exterior lighting, the lighting device 7 has a lighting area IIB located on the right side of the vehicle 11 from the right door. Thus, when the lighting devices 6 and 7 are used as the exterior lightings, the lighting devices 6 and 7 have illuminating areas on the left side and the right side of the vehicle 11, which are different from a lighting area IIC of a head lamp provided on a front side of the vehicle 11 and a lighting area IID of a tail lamp provided on a rear side of the vehicle 11.

The lighting devices 6 and 7 can be activated or deactivated by turning on and off a lighting switch 12. A switch signal corresponding to an on-off state of the lighting switch 12 is sent to the controller 5, and an on-off state of the lighting devices 6 and 7 can be switched through the controller 5. Each of the lighting devices 6 and 7 has a cover, and at least a portion of respective covers on the outside of the vehicle compartment may be a transparent for increasing the illumination on the outside of the vehicle compartment.

Each of the driving devices 8 and 9 is an actuator such as a motor. The driving device 8 rotates the lighting device 6 on the axis approximately parallel to the front-rear direction so as to change a lighting direction of the lighting device 6. The driving device 9 rotates the lighting device 7 on the axis approximately parallel to the front-rear direction so as to change a lighting direction of the lighting device 7. The driving devices 8 and 9 are controlled by the controller 5.

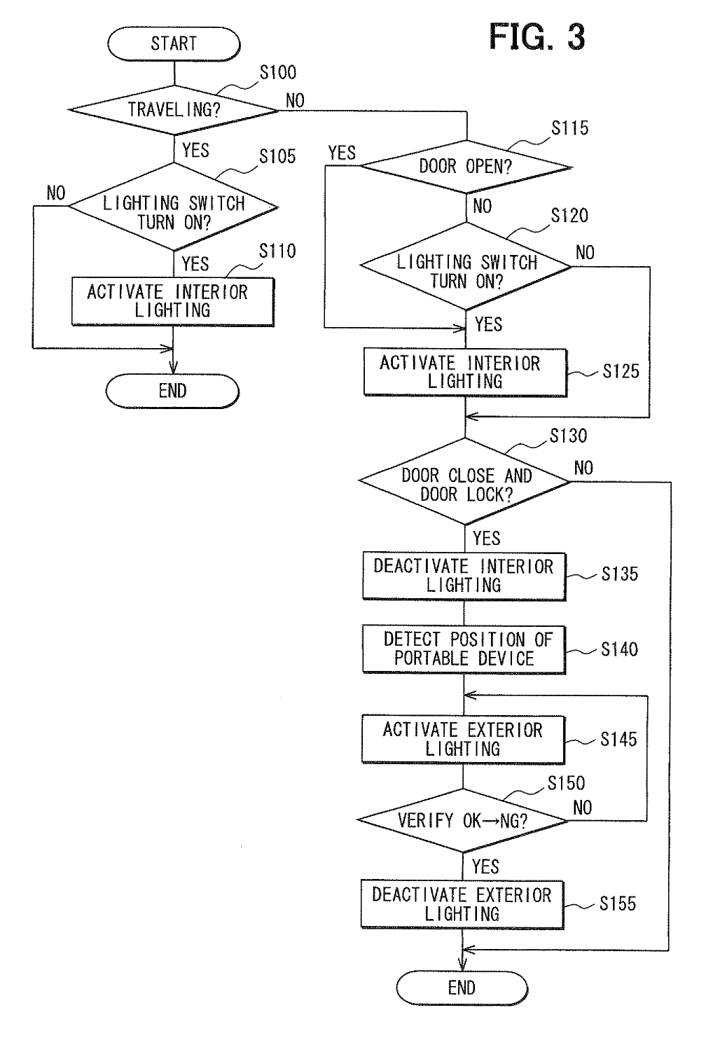

An exemplary process for controlling the lighting devices 6 and 7 performed by the controller 5 will now be described with reference to FIG. 3. The controller 5 executes the following process with a predetermined control cycle regardless of an on-off state of an ignition switch.

At S100, the controller 5 determines whether the vehicle 11 is traveling. The controller 5 makes the determination based on the detecting signal from the traveling detector 3. When the vehicle 11 is traveling, which corresponds to “YES” at S100, a foot illumination for the user is not required. Thus, the controller 5 determines whether the lighting switch 12 is turned on at S105. When the controller 5 determines that the lighting switch 12 is turned on, which corresponds to “YES” at S105, the controller 5 sends the control signal to the lighting devices 6 and 7 so as to illuminate a portion in the vehicle compartment other than a driver's seat, For example, when the driver's seat is arranged on the right side of the vehicle compartment, the controller 5 activates only the lighting device 6 disposed on the left side of the vehicle compartment. Then, the controller 5 ends the process. When the controller 5 determines that the lighting switch 12 is not turned on, which corresponds to “NO” at S105, the controller 5 ends the process. In this way, when the lighting switch 12 is turned on while the vehicle 11 is traveling, the controller 5 activates only one of the lighting devices 6 and 7 disposed at a side of the vehicle compartment without the driver's seat. Thus, a driving of the vehicle 11 is not disturbed.

When the controller 5 determines that the vehicle 11 is not traveling, which corresponds to “NO” at S100, the controller 5 proceeds the process to S115. At S115, the controller 5 determines whether each of the door opens based on the detecting signal from the door-state detector 4. In addition, the controller 5 determines whether the lighting switch 12 is turned on at S120. When at least one of the doors is open, which corresponds to “YES” at S115, or when all the doors are closed and the lighting switch 12 is turned on, which corresponds to “YES” at S120, the controller 5 activates the lighting devices 6 and 7 as the interior lightings at S125. When all the doors are closed and the lighting switch 12 is not turned on, which corresponds to “NO” at S120, the controller 5 proceeds the process to S130.

At S130, the controller 5 determines whether all the doors are closed and are locked. If the controller 5 determines that not all the doors are closed or not all the doors are locked, which corresponds to “NO” at S130, the controller 5 determines that the user has unlocked one of the doors or the user has opened one of the doors. In the present case, the foot illumination for the user is not required. Thus, the controller 5 ends the process. If the controller 5 determines that all the doors are closed and are locked, which corresponds to “YES” at S130, the controller 5 deactivates the lighting devices 6 and 7 functioning as the interior lightings at S135. At S140, the controller 5 detects the position of the portable device 10.

The controller 5 outputs the confirming signal through the exterior antennas 2. Then, the controller 5 determines which exterior antenna 2 receives the reply signal from the portable device 10. As described above, each of the exterior antennas 2 has the communicating area at the different portion. For example, when the exterior antenna 2 disposed on the right side of the vehicle 11 receives the reply signal from the portable device 10, the controller 5 determines that the portable device 10 is on the right side of the vehicle 11.

At S145, the controller 5 sends the control signal to one of the lighting devices 6 and 7 and one of the driving devices 8 and 9 located on a side where the portable device 10 is detected In accordance with the control signal from the controller 5, the one of the driving devices 8 and 9 rotates the corresponding one of the lighting devices 6 and 7 on the axis approximately parallel to the front-rear direction of the vehicle 11 and the corresponding one of the lighting devices 6 and 7 is activated so as to illuminate the outside of the vehicle. Thereby, the foot illumination can be provided on the side where the user is.

The foot illumination is deactivated when the user opens the door or when the user unlocks the door In addition, the foot illumination is not required when the user moves away from the vehicle 11. Thus, at S150, the controller 5 determines whether the user moves away from the vehicle 11. For example, the controller 5 receives the reply signal from the portable device 10 and verifies that the identification code of the reply signal corresponds to the identification code stored in the controller 5. When the verification of the identification codes changes from “OK” state to “NG” state, that is, when the user having the portable device 10 moves from an inside of the communicating area of the one of the exterior antennas 2 to an outside of the communicating area, the controller 5 deactivates the one of the lighting device 6 and 7 functioning as the exterior lighting at S155.

In this way, when the user comes close to the vehicle 11, one of the driving devices 8 and 9 drives corresponding one of the lighting devices 6 and 7 so as to illuminate the outside of the vehicle 11, and thereby the lighting control apparatus provides the foot illumination to the user. In addition, when the user gets out of the vehicle 11 and closes and locks the door, the lighting control apparatus starts to provide the foot illumination to the user. The lighting control apparatus keeps the foot illumination until the user moves away from the vehicle 11.

In the lighting control apparatus according to the present embodiment, each of the lighting devices 6 and 7 is configured to be used as the interior lighting and the exterior lighting. When the user comes close to the vehicle 11, the lighting control apparatus uses one of the lighting devices 6 and 7 as the exterior lighting for providing the foot illumination to the user. Thus, the lighting control apparatus can illuminate the portion in the vicinity of the door for assisting the user sufficiently without disposing additional lighting device at a door mirror.

### Second Embodiment

A lighting control apparatus according to a second embodiment of the invention does not include the driving devices 8 and 9 provided in the lighting control apparatus according to the first embodiment. Other components in the present lighting control apparatus are similar to those in the lighting control apparatus according to the first embodiment.

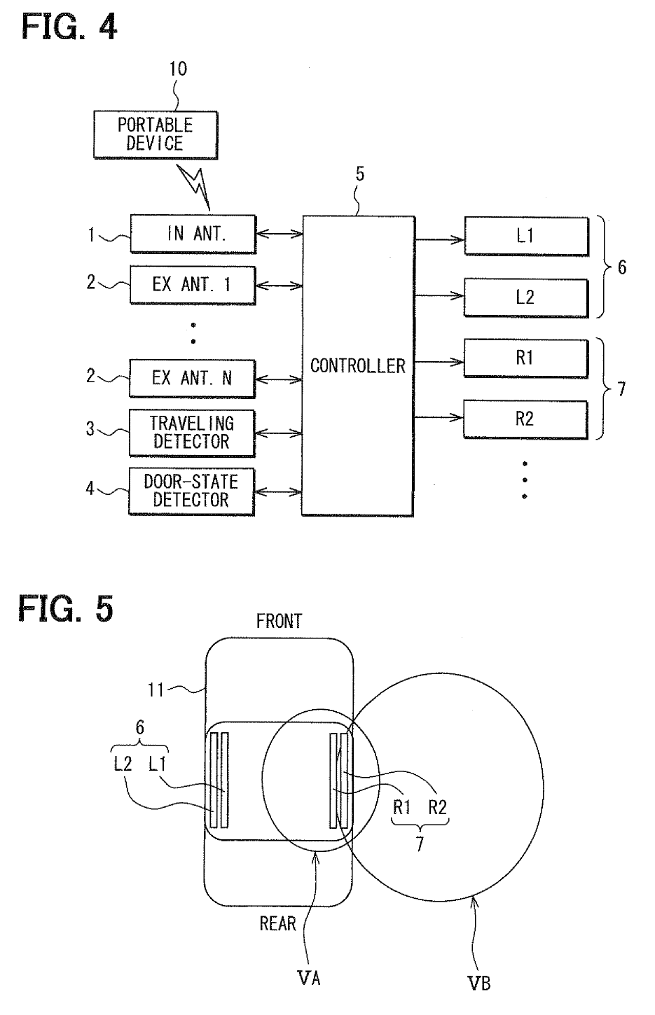

As illustrated in FIG. 4 and FIG. 5, the lighting device 6 located on the left side of the roof includes a left first lighting element L1 for illuminating the inside of the vehicle compartment and a left second lighting element L2 for illuminating the outside of the vehicle compartment. The left first lighting element L1 and the left second lighting element L2 have different lighting directions. When the left first lighting element L1 is activated, the lighting device 6 can illuminate the inside of the vehicle compartment. When the left second lighting element L2 is activated the lighting device 6 can illuminate the outside of the vehicle compartment. Similarly, the lighting device 7 located on the right side of the roof includes a right first lighting element R1 for illuminating the inside of the vehicle compartment and a right second lighting element R2 for illuminating the outside of the vehicle compartment. The right first lighting element R1 and the right second lighting element R2 have different lighting directions. When the right first lighting element R1 is activated, the lighting device 7 can illuminate the inside of the vehicle compartment. When the right second lighting element R2 is activated, the lighting device 7 can illuminate the outside of the vehicle compartment. For example, as illustrated in FIG. 5, when the right first lighting element R1 is activated, the lighting device 7 has a lighting area VA including a right half of the vehicle compartment. When the right second lighting element R2 is activated, the lighting device 7 has a lighting area VB at a predetermined area on the right side of the door. Thus, when the lighting device 6 is used as the exterior light, that is, when the left second lighting element L2 is activated, the left side of the vehicle 11 can be illuminated. When the lighting device 7 is used as the exterior light, that is, when the right second lighting element R2 is activated, the right side of the vehicle 11 can be illuminated.

In the present case, the interior lighting and the exterior lighting can be switched when the on-off states of the left first lighting element L1 and the left second lighting element L2 of the lighting device 6 are switched or when the on-off states of the right first lighting element R1 and the right second lighting element R2 of the lighting device 7 are switched. Thus, the driving devices 8 and 9 provided in the lighting control apparatus according to the first embodiment are not required. As a result, the present lighting control apparatus can have effects similar to those of the lighting control apparatus according to the first embodiment. In addition, the present lighting control apparatus can have simple structure compared with the lighting control apparatus according to the first embodiment.

### Third Embodiment

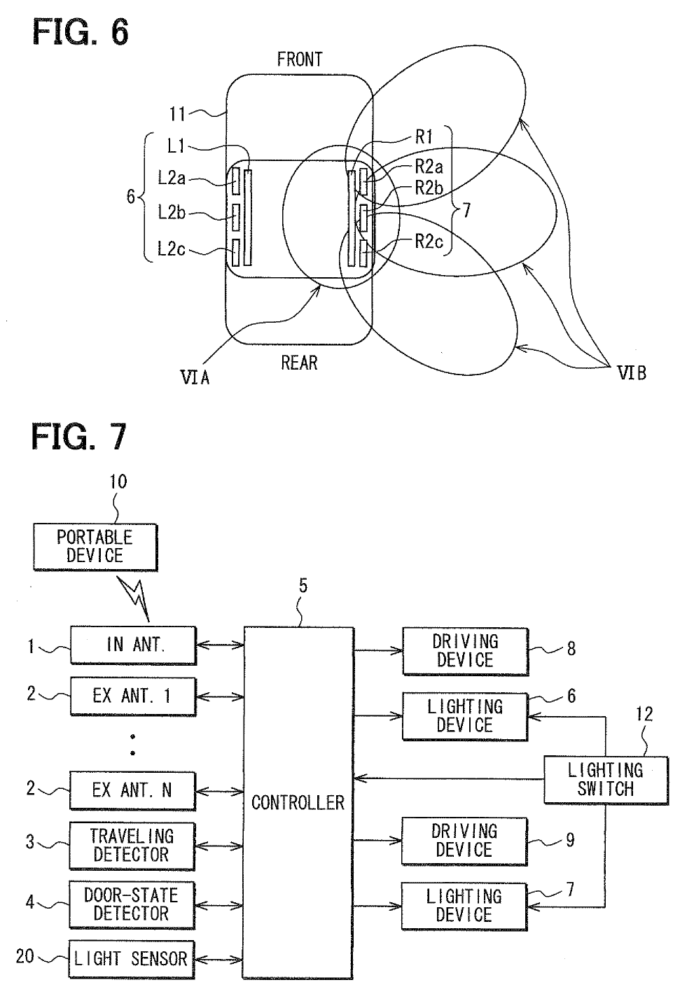

In a lighting control apparatus according to a third embodiment of the invention, the left second lighting element L2 includes three lighting portions L2a-L2c, and the right second lighting element R2 includes three lighting portions R2a-R2c, as illustrated in FIG. 6

For example, the left second lighting element L2 of the lighting device 6 includes a first lighting portion L2a for illuminating a left front side of the vehicle 11, a second lighting portion L2b for illuminating a left side of the vehicle 11, and a third lighting portion L2c for illuminating a left rear side of the vehicle 11. The right second lighting element R2 of the lighting device 7 includes a first lighting portion R2a for illuminating a right front side of the vehicle 11, a second lighting portion R2b for illuminating a right side of the vehicle 11, and a third lighting portion R2c for illuminating a right rear side of the vehicle 11.

In this way, when each of the left second lighting element L2 and the right second lighting element R2 includes a plurality of lighting portions, the foot illumination can be provided at a specific area. For example, when the user comes close to the vehicle 11 from the right front side, the foot illumination is provided by using the first lighting portion R2a for illuminating the right front side. When the user further comes close to the right door, the foot illumination is provided by using the second lighting portion R2b for illuminating the right side of the vehicle 11. In the present case, the exterior antennas 2 are disposed at the left front side, the left side, the left rear side, the right front side, the right side, and the right rear side, respectively, so as to correspond to the first to third lighting portions L2a-L2c of the lighting device 6 and the first to third lighting portions R2a-R2c of the lighting device 7. The communicating areas of adjacent exterior antennas 2 may overlap each other. In the present case, when the user moves from one communicating area to an adjacent communicating area, the foot illumination at the adjacent communicating area can be provided prior to the movement of the user.

When the user moves from the right front side to the right side, the user goes out of the communicating area of the exterior antenna 2 corresponding to the first lighting portion R2a and comes into the communicating area of the exterior antenna 2 corresponding to the second lighting portion R2b. In the present case, the first lighting portion R2a may be deactivated for reducing power consumption. In a case where the first lighting portion R2a is deactivated just after the user goes out of the communicating area of the exterior antenna 2 corresponding to the first portion R2a, when the user goes back and fourth over a boundary of the communicating areas, the activation and the deactivation of the first lighting portion R2a is repeated. Thus, the first lighting portion R2a may be deactivated after a lapse of a predetermined time after the user goes out the communicating area of the exterior antenna 2 corresponding to the first lighting portion R2a.

### Fourth Embodiment

A lighting control apparatus according to a fourth embodiment of the invention provides the foot illumination to the user only when a periphery of the vehicle 11 is dark.

As illustrated in FIG. 7, the present lighting control apparatus includes a light sensor 20. The light sensor 20 detects brightness, e.g., the amount of light of the periphery of the vehicle 11 and sends a detecting signal to the controller 5 in accordance with the amount of light.

The controller 5 determines whether the amount of light is greater than a threshold value based on the detecting signal from the light sensor 20. When the amount of light is greater than the threshold value, the controller 5 determines that the periphery of the vehicle is light and the foot illumination is not required. Thus, the controller 5 may not provide the foot illumination when the amount of the light is greater than the threshold value and the controller may provide the foot illumination only when the amount of light is less than or equal to the threshold value. For example, a process for determining whether the amount of light is greater than the threshold value may be performed before the process at S15 in FIG. 3. When the amount of light is greater than the threshold value, the controller 5 ends the process for controlling the lighting control apparatus. When the amount of light is less than or equal to the threshold value, the controller 5 proceeds the process to S115.

The present lighting control apparatus can be prevented from providing the foot illumination when the periphery of the vehicle 11 is light and the foot illumination is not required.

### Other Embodiments

Although the present invention has been fully described in connection with the preferred embodiments thereof with reference to the accompanying drawings, it is to be noted that various changes and modifications will become apparent to those skilled in the art.

In the first to third embodiments, the portable device 10, the interior antenna 1, and the exterior antenna 2 are shared by the smart entry system and the lighting control apparatus. Alternatively, a portable device, an interior antenna, and exterior antennas for the smart entry system and the portable device 10, the interior antenna 1, and the exterior antenna 2 for the lighting control apparatus may be provided separately.

In the third embodiment, each of the left second lighting element L2 and the right second lighting element R2 includes three lighting portions, as an example. Each of second lighting elements L2 and R2 may also include two lighting portions. Alternatively, each of the second lighting elements L2 and R2 may include a plurality of lighting portions greater than or equal to four as long as a plurality of exterior antenna corresponding to the plurality of lighting portions can be disposed.

In the fourth embodiment, the light sensor 20 is provided for detecting the brightness of the periphery of the vehicle 11. When a camera for monitoring the periphery of the vehicle 11 is provided in the vehicle 1 the controller 5 may determine the amount of light based on an image taken by the camera. Alternatively, the controller 5 may determine the brightness by determining day or night based on a time.

What is claimed is:

1. A lighting control apparatus for a vehicle, comprising:
a portable device;
an interior antenna having a communicating area at an inside of a vehicle compartment;
an exterior antenna having a communicating area at an outside of the vehicle compartment;
a controller for determining a position of the portable device through one of the interior antenna and the exterior antenna when the portable device is in the communicating area of the one of the interior antenna and the exterior antenna;
a first lighting device disposed at a portion of a roof of the vehicle adjacent to a left door of the vehicle; and
a second lighting device disposed at a portion of the roof adjacent to a right door of the vehicle, wherein:
each of the first lighting device and the second lighting device is configured to illuminate one of the inside of the vehicle compartment and the outside of the vehicle compartment in accordance with a control signal from the controller;
the controller sends the control signal to one of the first lighting device and the second lighting device so as to illuminate the inside of the vehicle compartment when the controller determines that the portable device is in the communicating area of the interior antenna; and
the controller sends the control signal to one of the first lighting device and the second lighting device so as to illuminate the outside of the vehicle compartment when the controller determines that the portable device is in the communicating area of the exterior antenna.

2. The lighting control apparatus according to claim 1, wherein:
the exterior antenna includes a first exterior antenna element having a communicating area on a left side of the vehicle and a second exterior antenna element having a communicating are on a right side of the vehicle;
the controller sends the control signal to the first lighting device so as to illuminate the left side of the vehicle when the controller determines that the portable device is in the communicating area of the first exterior antenna element; and
the controller sends the control signal to the second lighting device so as to illuminate the right side of the vehicle when the controller determines that the portable device is in the communicating area of the second exterior antenna element.

3. The lighting control apparatus according to claim 1, further comprising:
a first driving device for switching a lighting direction of the first lighting device between the inside of the vehicle compartment and the outside of the vehicle compartment in accordance with the control signal from the controller; and
a second driving device for switching a lighting direction of the second lighting device between the inside of the vehicle compartment and the outside of the vehicle compartment in accordance with the control signal from the controller.

4. The lighting control apparatus according to claim 3, wherein:
the first driving device switches the lighting direction of the first lighting device by rotating the first lighting device on an axis approximately parallel to a front-rear direction of the vehicle; and
the second driving device switches the lighting direction of the second lighting device by rotating the second lighting device on an axis approximately parallel to the front-rear direction of the vehicle.

5. The lighting control apparatus according to claim 1, wherein:
each of the first lighting device and the second lighting device includes a first lighting element having a lighting direction toward the inside of the vehicle compartment and a second lighting element having a lighting direction toward the outside of the vehicle compartment;
the controller activates one of the first lighting elements when the controller determines that the portable device is in the communicating area of the interior antenna; and
the controller activates one of the second lighting elements when the controller determines that portable device is in the communicating area of the exterior antenna.

6. The lighting control apparatus according to claim 5, wherein:
each of the second lighting elements includes a plurality of lighting portions which are arranged in a front-rear direction of the vehicle;
the exterior antenna includes a plurality of exterior antenna elements each corresponding to respective one of the plurality of lighting portions and each having a different communicating area; and
the controller activates one of the plurality of lighting portions when the controller determines that the portable device is in the communicating area of corresponding one of the plurality of exterior antenna elements.

7. The lighting control apparatus according to claim 1, further comprising:
a traveling detector for detecting whether the vehicle is traveling, the traveling detector sending a detecting signal to the controller in accordance with the traveling state of the vehicle; and
a lighting switch for sending a switching signal to the controller so as to activate and deactivate the first lighting device and the second lighting device regardless of the position of the portable device, wherein:
the controller activates only one of the first lighting device and the second lighting device disposed at a side of the vehicle compartment without a driving seat even when the controller receives the switching signal from the lighting switch so as to activate the first lighting device and the second lighting device while the controller determines that the vehicle is traveling based on the detecting signal from the traveling detector.

8. The lighting control apparatus according to claim 1, further comprising
a brightness detecting part for detecting a brightness of a periphery of the vehicle, the brightness detecting part sending a detecting signal to the controller in accordance with the brightness of the periphery, wherein
the controller deactivates the first lighting device and the second lighting device when the controller determines that the periphery of the vehicle is light based on the detecting signal from the brightness detecting part.

9. The lighting control apparatus according to claim 8, wherein:
the brightness detecting part includes a light sensor for detecting an amount of light of the periphery; and
the controller deactivates the first lighting device and the second lighting device when the controller determines that the amount of light is greater than a threshold value.
